(19) United States
(12) Patent Application Publication
(10) Pub. No.: US 2025/0016660 A1
(43) Pub. Date: Jan. 9, 2025

(54) METHOD OF WIRELESS COMMUNICATION AND RELATED DEVICES

(71) Applicant: PURPLEVINE INNOVATION COMPANY LIMITED, Hong Kong (HK)

(72) Inventor: Chiu-Wen CHEN, Hong Kong (HK)

(73) Assignee: PURPLEVINE INNOVATION COMPANY LIMITED, Hong Kong (HK)

(21) Appl. No.: 18/705,584

(22) PCT Filed: Oct. 28, 2022
(86) PCT No.: PCT/CN2022/128164

§ 371 Date: Apr. 28, 2024

Related U.S. Application Data
(60) Provisional application No. 63/272,718, filed on Oct. 28, 2021.

(51) Int. Cl. H04W 48/10; H04W 8/22; H04W 24/10; H04W 76/40

(52) U.S. Cl. CPC H04W 48/10; H04W 8/22; H04W 24/10; H04W 76/40

(57) ABSTRACT

A method of wireless communication is provided. The method includes receiving UE assistance information from user equipment (UEs); and transmitting, by the network node, unicast and a broadcast service simultaneously on a common physical channel based on the UE assistance information. With this method, better resource efficiency and flexible transmission are realized based on the UE assistance information.

### TECHNICAL FIELD

The present disclosure relates to the field of wireless communications, and more particularly, to a method of wireless communication and related devices.

### BACKGROUND ART

Communication systems and networks have developed towards being a broadband and mobile system. In cellular wireless communication systems developed by the Third Generation Partnership Project (3GPP), user equipment (UE) is connected by a wireless link to a radio access network (RAN). The RAN includes a set of base stations (BSs) which provide wireless links to the UEs located in cells covered by the base station, and an interface to a core network (CN) which provides overall network control. As will be appreciated the RAN and CN each conduct respective functions in relation to the overall network. The 3GPP has developed the so-called Long Term Evolution (LTE) system, namely, an Evolved Universal Mobile Telecommunication System Territorial Radio Access Network (E-UTRAN), for a mobile access network where one or more macro-cells are supported by a base station known as an eNodeB or eNB (evolved NodeB). More recently, evolved from LTE, the so-called 5G or New radio (NR) systems where one or more cells are supported by a base station known as a gNB.

A broadcasting service may need to be integrated in 5G NR. 3GPP has developed NR broadcast/multicast in Rel-17. Other broadcasting services may be considered. For example, Free-to-air (FTA) is a service for terrestrial broadcasting that are not encrypted. FTA also refers to the broadcasters providing content for which no subscription is expected, even though they may be delivered to the receiver by another carrier for which a subscription is required, e.g., cable television, the Internet, or satellite.

In 5G NR multicast and broadcast service (NR MBS), Single-Cell Point-to-Multipoint (SC-PTM) transmission is the baseline. In SC-PTM, broadcast/multicast services are provided over a single cell in which the broadcast/multicast area can be dynamically adjusted cell by cell according to user distribution. To fulfill the requirement from various 5G services (e.g., terrestrial broadcasting, public safety, mission critical, V2X applications, transparent IPv4/IPv6 multicast delivery, IPTV, software delivery over wireless, group communications and IoT applications, etc.), NR MBS framework is required to support simultaneous NR MBS and/or FTA service with unicast traffic.

### SUMMARY

An object of the present disclosure is to propose a method of wireless communication and related devices, which can solve issues in the prior art, improve an issue of increasing in service requirement and inter-site interference, provide a good communication performance, and/or provide high resource efficiency.

In a first aspect of the present disclosure, provided is a method of wireless communication, including: receiving UE assistance information from user equipment (UEs); and transmitting, by the network node, unicast and a broadcast service simultaneously on a common physical channel based on the UE assistance information.

In a second aspect of the present disclosure, provided is a method of wireless communication, including: transmitting UE assistance information to a network node; and receiving, by a user equipment (UE), unicast and a broadcast service simultaneously transmitted on a common physical channel based on the UE assistance information from the network node.

In a third aspect of the present disclosure, a user equipment includes a memory, at least one transceiver and a processor coupled to the memory and the at least one transceiver, the processor configured to call and run program instructions stored in a memory, to execute the above method.

In a fourth aspect of the present disclosure, a base station includes a memory, at least one transceiver and a processor coupled to the memory and the at least one transceiver, the processor configured to call and run program instructions stored in a memory, to execute the above method.

In a fifth aspect of the present disclosure, a non-transitory machine-readable storage medium has stored thereon instructions that, when executed by a computer, cause the computer to perform the above method.

In a sixth aspect of the present disclosure, a chip includes a processor, configured to call and run a computer program stored in a memory, to cause a device in which the chip is installed to execute the above method.

In a seventh aspect of the present disclosure, a computer readable storage medium, in which a computer program is stored, causes a computer to execute the above method.

In an eighth aspect of the present disclosure, a computer program product includes a computer program, and the computer program causes a computer to execute the above method.

In a tenth aspect of the present disclosure, a computer program causes a computer to execute the above method.

### DESCRIPTION OF DRAWINGS

In order to more clearly illustrate the embodiments of the present disclosure or related art, the following figures will be described in the embodiments are briefly introduced. It is obvious that the drawings are merely some embodiments of the present disclosure, a person having ordinary skill in this field can obtain other figures according to these figures without paying the premise.

FIG. 1(a) is a schematic diagram illustrating a communication controlling system according to an embodiment of the present disclosure.

FIG. 1(b) is a block diagram of a user equipment and a base station of wireless communication in a communication controlling system according to an embodiment of the present disclosure.

FIG. 2 is a schematic diagram illustrating radio protocol architecture within gNB and UE.

FIG. 3 is a schematic diagram illustrating a gNB further including a centralized unit (CU) and a plurality of distributed unit (DUs).

FIG. 4 is a flowchart of a method of wireless communication according to an embodiment of the present disclosure.

FIG. 5 is a schematic diagram illustrating network-initiated UE assistance information report for FTA service according to an embodiment of the present disclosure.

FIG. 6 is a schematic diagram illustrating UE-initiated UE assistance information report for FTA service according to an embodiment of the present disclosure.

FIG. 7 is a schematic diagram illustrating an example of unicast, NR MBS and NR-SFN transmission according to an embodiment of the present disclosure.

FIG. 8 is a schematic diagram illustrating network-initiated UE assistance information report for NR-SFN transmission according to an embodiment of the present disclosure.

FIG. 9 is a schematic diagram illustrating UE-initiated UE assistance information report for NR-SFN transmission according to an embodiment of the present disclosure.

FIG. 10 is a schematic diagram illustrating RAN-based synchronization according to an embodiment of the present disclosure.

### DETAILED DESCRIPTION OF EMBODIMENTS

Embodiments of the disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

In this document, the term “/” should be interpreted to indicate “and/or.” A combination such as “at least one of A, B, or C,” “one or more of A, B, or C,” “at least one of A, B, and C,” “one or more of A, B, and C,” or “A, B, and/or C” may be A only, B only, C only, A and B, A and 30 C, B and C, or A and B and C, where any combination may contain one or more members of A, B, or C.

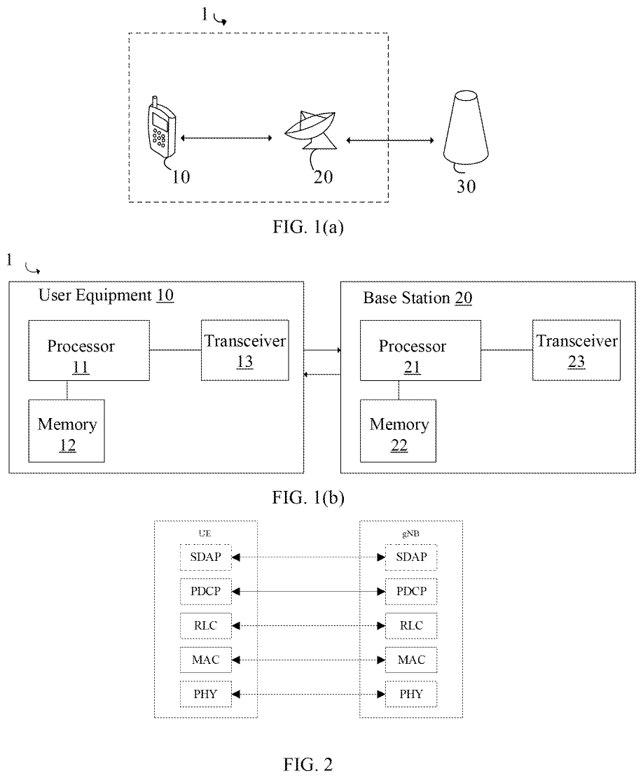

A schematic view and a functional block diagram of a communication controlling system 1 according to the present disclosure are shown in FIG. 1(a) and FIG. 1(b) respectively. The communication controlling system 1 includes a user equipment 10 and a base station 20. The user equipment 10 is a smartphone, for example. The base station 20 is a gNB as an example of a network node. The user equipment 10 and the base station 20 may communicate with each other either wirelessly or in a wired way. The base station 20 and a next generation core network 30 may also communicate with each other either wirelessly or in a wired way. When the communication controlling system 1 complies with the New Radio (NR) standard of the 3rd Generation Partnership Project (3GPP), the next generation core network (5GCN) 30 is a backend serving network system and may include an Access and Mobility Management Function (AMF), User Plane Function (UPF), and a Session Management Function (SMF). The user equipment 10 may be a multicast and broadcast service (MBS) capable apparatus or a non-MBS capable apparatus, but the present disclosure is not limited to this. The user equipment 10 includes a processor 11, a memory 12, and at least one transceiver 13. The processor 11 is coupled to the memory 12 and the transceiver 13. The transceiver 13 of the user equipment 10 is configured to transmit a signal to the base station 20 so that the user equipment 10 communicates with the base station 20 each other. The base station 20 may include a processor 21, a memory 22, and at least one transceiver 23. The processor 21 is coupled to the memory 22 and the transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21, and the transceiver 13 or 23 transmits and/or receives a radio signal. In one aspect, the user equipment 10 can include most any consumer electronic device or appliance that can connect to a radio access network and a core network for the releases of 3GPP and further, such as, but not limited to NR networks.

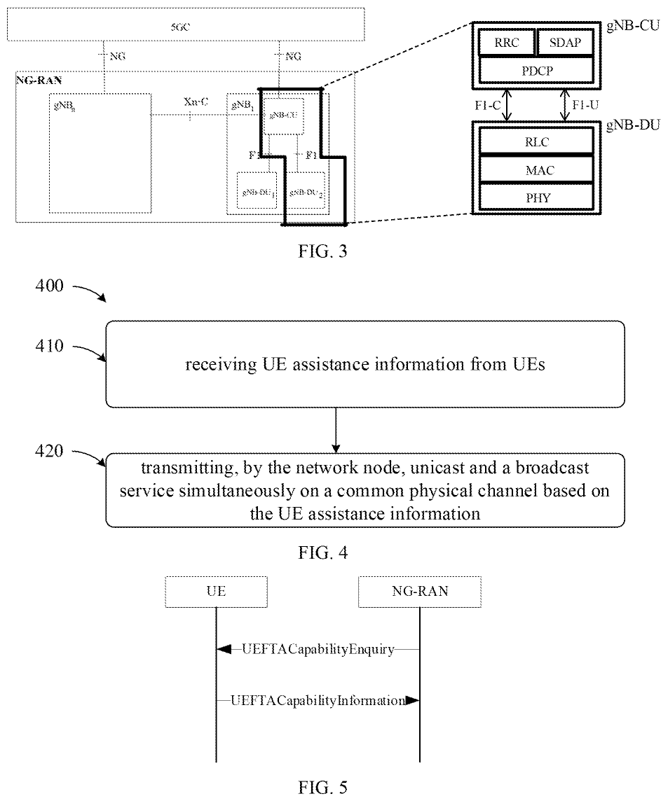

Point to multipoint transmission in a cell (i.e., single cell-point to multipoint, SC-PTM) and/or single frequency network (NR-SFN) are supported for new radio multicast and broadcast service (NR MBS). In SC-PTM, broadcast/multicast services are provided over a single cell in which the broadcast/multicast area can be dynamically adjusted cell by cell according to user distribution. In SFN, several transmitters simultaneously transmit the same signal over the same frequency channel. The user plane radio protocol architecture within the gNB and UE for NR MBS is shown in FIG. 2, which includes optional Service Data Adaptation Protocol (SDAP), Packet Data Convergence Protocol (PDCP), Radio Link Control (RLC), Medium Access Control (MAC). In RAN functional split for supporting NR MBS, a gNB further includes a centralized unit (CU) and a plurality of distributed unit (DUs) as shown in FIG. 3. The protocol stack of CU includes an RRC layer, an optional SDAP layer, and a PDCP layer, while the protocol stack of DU includes an RLC layer, a MAC layer, and a PHY layer. The F1 interface between the CU and DU is established between the PDCP layer and the RLC layer. In case of radio access network (RAN) sharing with multiple cell identifiers broadcast, each cell identifier associated with a subset of public land mobile networks (PLMNs) corresponds to a gNB-DU and the gNB-CU it is connected to, i.e., the corresponding gNB-DUs share the same physical layer cell resources for NR MBS and FTA service. Each cell of the shared RAN should also indicate the available PLMN identifiers in the system information for selection by UEs.

FIG. 4 illustrates a method 400 of wireless communication according to an embodiment of the present disclosure. The method 400 is performed by a network node (e.g., gNB) in a network. The method 400 may include the following steps.

In Block 410, the network node receives UE assistance information from user equipment (UEs).

The UE assistance information may include UE capability, which may indicate whether it supports broadcast reception or which frequency bands are used for broadcast reception, for example. The UE assistance information may also include measurement report of neighboring cells, for example. In special scenarios, other information such as Free-to-Air (FTA) reception/Radio Access Network (RAN) sharing status report may be included in the UE assistance information. In an embodiment, reporting of the UE assistance information may be initiated by the network node. That is, when the network node needs additional UE capability information, it may request the UE to transmit the UE capability information. In another embodiment, reporting of the UE assistance information may be initiated by the UE. That is, when the UE would like to receive the broadcast, the UE may initiate transmission of the UE assistance information.

The UE assistance information is used to assist the network node to configure radio resources for the UE(s) to receive unicast and broadcast service simultaneously. For example, with this UE assistance information, the network node may determine a frequency band for the broadcast service, and then unicast can be transmitted within the frequency band. Since the allocation of the radio resources is mainly controlled by the network node such as a gNB, this procedure would be RAN-based, different from a Core Network (CN)-based procedure.

In various use cases, the network node may be one of the followings: one of cells of intra-distributed unit (DU), one of cells of inter-DU of intra-centralized unit (CU), one of cells of inter-CU, one of cells of primary/secondary carrier component, one of cells of master/secondary cell group, or one of cells of sharing public land mobile networks (PLMNs).

In Block 420, the network node transmits to UE(s) unicast and a broadcast service simultaneously on a common physical channel based on the UE assistance information.

The broadcast service may include FTA or multicast and broadcast service (MBS) (particularly, MBS broadcast) or both the FTA and the MBS. That is to say, the network node may transmit the unicast and the broadcast service including at least one of the FTA or MBS. The network node is configured to enable simultaneous unicast and broadcast service on a common physical channel (e.g., PDCCH and PDSCH). More specifically, as an illustrated example, in Block 420 the unicast (and/or the MBS) is/are transmitted for the UE on resources configured according to the FTA after the FTA is determined to be transmitted. For example, after a frequency band is configured for FTA transmission, radio resources for unicast (and/or MBS) transmission are configured accordingly. This would realize better resource efficiency and flexible transmission since unicast and other broadcast or multicast service such as MBS are allowed to be transmitted on the resources determined based on the FTA.

In an embodiment, the broadcast service is transmitted under a RAN-based single frequency network (SFN). That is, different cells simultaneously transmit the broadcast service with the same signal over the same frequency channel. The network node, providing the broadcast service towards the UEs, decides to transmit broadcast data within a RAN-based SFN service area based on the UE assistance information. In addition, unicast and/or MBS are allowed to be transmitted simultaneously with FTA under the RAN-based SFN.

In an embodiment, the network node decides to utilize RAN-based SFN or SC-PTM to transmit MBS. The network node may configure SC-PTM and RAN-based SFN transmission for cell-center UEs and cell-edge UEs respectively depending on the UE assistance information. The network may configure adaptive modulation and coding scheme (MCS) to SC-PTM and RAN-based SFN transmission for cell-center UEs and cell-edge UEs respectively depending on the UE assistance information.

With the proposed method 400 illustrated above, the invention can solve issues in the prior art, provide better resource efficiency and flexible transmission based on UE assistance information, improve an issue of increasing in service requirement and inter-site interference, provide a good communication performance, and/or provide high resource efficiency.

Other details of this application are described below.

Free-to-Air (FTA) service, as an example, is a broadcasting service for free without device subscription whereas NR MBS requires subscription. High power high tower (HPHT) and/or low power low tower (LPLT) network should be considered as FTA structure. FTA in Receive-only mode (ROM) deployment is configured to enable SIM-free reception. It means that UICC or USIM is not required for UE in ROM. The broadcast solution in NR MBS provides the UE to receive FTA service in a downlink only manner. When a UE is capable of receiving-only mode, it may receive FTA on the pre-configured range/area/subframe/frequency/carrier/cell and does not need to establish connection with NG-RAN node for FTA services. In addition to SIM-free ROM, the other mode named integrated ROM enables the UE to operate as a normal UE (i.e., with at least a SIM card) for network access (i.e., unicast service, some other multicast and broadcast services) simultaneously. USIM would be required for this integrated ROM operations. In some integrated ROM use cases, the UE supports multiple SIM cards to receive FTA service and network service from the same or different operators.

In this application, for the sake of network resource allocation and interference avoidance, the UE should report some assistance information (e.g., UE capability, measurement report, FTA reception/RAN sharing status report, etc.) to the NG-RAN node. When the NG-RAN node is aware of UE capability, channel quality and/or the range/area/subframe/frequency/carrier/cell where the UE receives FTA, the NG-RAN node could configure the resource for the UE accordingly.

In some embodiments, the NG-RAN node initiates the procedure to a UE in RRC_CONNECTED when it needs additional UE capability information for FTA as shown in FIG. 5. The UEFTACapabilityEnquiry information element (e.g., via a system information block or a new RRC message) is used to request UE radio access capabilities for FTA as well as for RAN sharing. The network may transmit at least one supported bandwidth, subcarrier spacing and UEFTACapability Enquiry information element (IE) to request the supported FTA Band/FeatureSet combinations/RAN sharing type of UE. Upon the reception of UEFTACapabilityEnquiry, the UE shall set at least one of the contents in UEFTACapability Information information element (e.g., via MBSInterestIndication or a new RRC message) as follows:
FTA Band/FeatureSet capability
FTA Band combinations supported by the UE into FTAsupportedBandCombination
FTA FeatureSet combinations supported by the UE into FTAsupportedFeatureSetCombination
RAT-Type
FTA synchronization capability
wherein an FTA FeatureSet identifier is associated with one or more FTA frequency bands (e.g., ARFCN) within the corresponding band combination. RAT-Type is associated with UE supported RAT(s) including nr, eutra-nr, eutra, RAN sharing. FTA synchronization capability is the timing associated values (e.g., Timing Advance (TA) value, the time stamp of FTA reception) used for synchronization purposes as real numbers modulo the FTA transmission period defined in FTA. Based on the information, the NG-RAN node may derive the FTA transmission according to the following formula:

FTA synchronization={timing associated values} mod {period (FTA)}.

And then the NG-RAN node can also allocate unicast and/or NR MBS for the UE achieving better performance.

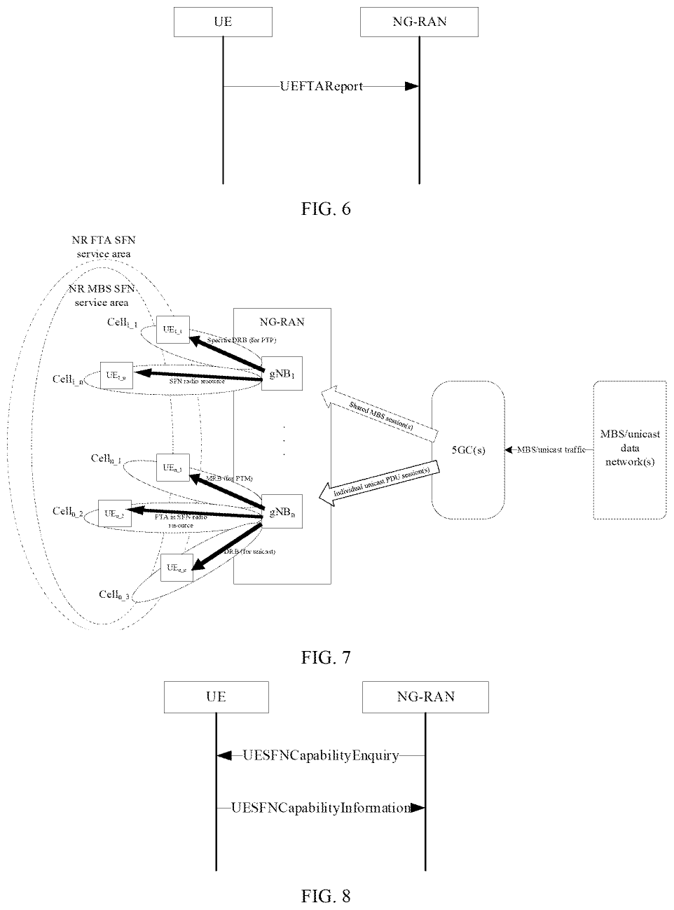

In some embodiments, the UE initiates the procedure as shown in FIG. 6 to the network in RRC_IDLE/RRC_INACTIVE/RRC_CONNECTED when it would like to receive FTA service in addition to normal network access. When the corresponding FTA event (e.g., UL/DL attempt(s) following FTA) is triggered or periodical, the UE shall set at least one of the contents in UEFTAReport information element (e.g., via MBSInterestIndication or a new RRC message) as follows:
The quantities per cell and/or per beam associated with FTA
FTA reception status
Maximum number of cells/beams per UE to receive.
RAT-Type
FTA synchronization capability

In embodiments of the present disclosure, FTA service and/or normal MBS traffic would be associated with single frequency operation in LPLT cellular structure. The mapping between frequency and FTA/MBS service identifier (e.g., service area identifier) may provide in the upper layer signaling (e.g., User Service Description (USD)). FTA may be transmitted simultaneously with or without MBS under a single frequency network (SFN), or only MBS is transmitted in this SFN. NR FTA/MBS single frequency network (NR-SFN) may provide RAN-based synchronized transmission of FTA/MBS data from different cells of the NG-RAN node(s). This means that UE(s) could receive FTA and/or MBS data within at least one NR-SFN service area as shown in FIG. 7. In some cases, NR-SFN is based on the existing frame structure and numerologies (e.g., regular cyclic prefix, subcarrier spacing) to cope with multipath propagation. The NG-RAN node can transmit unicast and FTA/MBS via DRB and/or MRB dynamically and simultaneously based on UE assistance information and RAN-based NR-SFN delivery procedure to accommodate different traffic within the cell(s). For coverage enhancement, the enhanced frame structure (e.g., RAN-based SFN subframe for FTA/MBS and unicast, group-common resource TDMed/FDMed with broadcast and unicast traffic, self-contained subframe for reliable NR MBS ACK/NACK, common frequency resource (CFR)) and numerologies (e.g., extended cyclic prefix, new subcarrier spacing) are used to enlarge the NR-SFN service area (i.e., not limited cells in intra-DU) and UE mobility upon achieving the QoS requirements of NR MBS. Both the existing and enhanced frame structure/numerologies can be co-existed with the RAN-based NR-SFN delivery procedure for backward compatibility. The flexible numerology allows a range of cyclic prefix and/or subcarrier spacing with different slot lengths. In some embodiments, a new configuration (e.g., NR-SFN identifier, numerologies, etc.) for NR-SFN transmission is transmitted in at least one system information block.

FIG. 7 is a schematic diagram illustrating an example of unicast, NR MBS and NR-SFN transmission according to an embodiment of the present disclosure. The 5G core networks (5GCs) receives FTA/NR MBS/unicast traffic from the FTA/MBS/unicast data networks respectively. For FTA/NR MBS broadcast communication, the shared FTA/MBS session (i.e., single copy of those FTA/MBS traffic) packet(s) would deliver to the NG-RAN node (e.g., gNB), which then transmits to one or more NR MBS-capable UEs. Whereas the individual unicast Packet Data Unit (PDU) session packet(s) would deliver to the individual UEs via per-UE PDU sessions for NR MBS/unicast communication. The NG-RAN node, providing NR MBS towards the UEs, can decide to transmit MBS data via multicast radio bearer (e.g., MRB) and/or unicast data radio bearer (e.g., specific DRB) based on MBS session QoS (e.g., reliability, BLER) requirements, number of interested UEs, estimated channel quality. It enables the NG-RAN node to decide for which UEs to use PTP or PTM for the MBS session. SC-PTM using point-to-multipoint (PTM) transmissions is delivered by MRB for a given UE(s) as well as the PDCCH-scheduled PTM PDSCH data is scrambled by a specific Group-RNTI (G-RNTI). SC-PTM using point-to-point (PTP) transmissions is delivered by the specific DRB with the scrambled C-RNTI for a given UE(s) as well as the PDCCH-scheduled PTP PDSCH data is scrambled by a specific Cell-RNTI (C-RNTI). When NR-SFN is supported, the NG-RAN node, providing FTA/MBS towards the UEs, can decide to transmit FTA/MBS data within NR-SFN service area based on UE assistance information (e.g., UE capability, measurement report, FTA reception/RAN sharing status report, etc.). In general, NR-SFN provides better performance than SC-PTM for cell-edge UEs due to transmission diversity. The NG-RAN node would configure adaptive modulation and coding scheme (MCS) to SC-PTM and NR-SFN transmission for cell-center UEs and cell-edge UEs respectively depending on UE assistance information, estimated channel quality, QoS requirement, if necessary. From UE perspective, based on UE's capability, the UE can receive unicast, NR MBS, FTA via DRB, MRB, SFN accordingly.

In some embodiments, the network initiates the procedure to a UE in RRC_CONNECTED when it needs additional NR-SFN UE radio access capability information. Upon the reception of UESFNCapabilityEnquiry information element (e.g., via a system information block or a new RRC message) as shown in FIG. 8, the UE shall set the contents of UESFNCapability Information information element (e.g., via MBSInterestIndication or a new RRC message) as follows:
SFN Band/FeatureSet capability
SFN Band combinations supported by the UE into SFNsupportedBandCombination
SFN FeatureSet combinations supported by the UE into SFNsupportedFeatureSetCombination
RAT-Type
SFN synchronization capability
wherein a SFN FeatureSet identifier is associated with one or more NR-SFN bands within the corresponding band combination. RAT-Type is associated with UE supported RAT(s) including nr, eutra-nr, eutra, RAN sharing. SFN synchronization capability is the timing associated values (e.g., Timing Advance (TA) value, the time stamp of NR-SFN reception) used for descriptive purposes as real numbers modulo the NR-SFN transmission period defined in the FTA/NR MBS. Based on the information, the NG-RAN node may derive the FTA/NR MBS transmission according to the following formula:

SFN synchronization= {timing associated values} mod {period (NR-SFN)}.

And then the NG-RAN node can also allocate unicast for the UE achieving better performance.

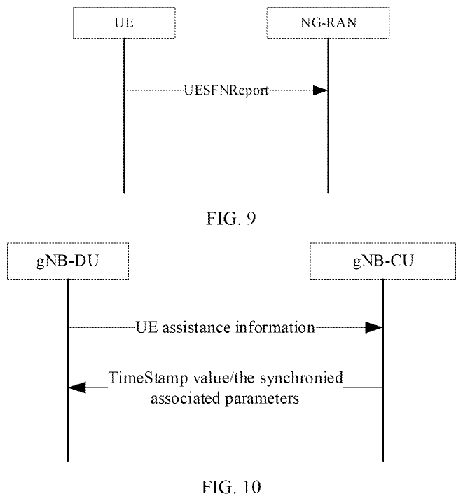

In some embodiments, the UE initiates the procedure as shown in FIG. 9 to the network in RRC_IDLE/RRC_INACTIVE/RRC_CONNECTED when it would like to receive SFN service in addition to normal network access. When the corresponding SFN event (e.g., UL/DL attempt(s) following SFN transmission) is triggered or periodical, the UE shall set at least one of the contents in UESFNReport information element (e.g., via

MBSInterestIndication or a new RRC message) as follows:
The quantities per cell and/or per beam associated with SFN
SFN reception status for FTA
Maximum number of cells/beams per UE to receive
RAT-Type
SFN synchronization capability

In embodiments of the present disclosure, the RAN-based NR-SFN delivery procedure provides multi-cell and SFN transmission using RAN-based synchronization method within NR-SFN service area (i.e., NR FTA SFN service area, NR MBS SFN service area). All the cells belonging to an NR-SFN service area configures the same SFN-specific reference/synchronized signal pattern for UE synchronization. This SFN-specific reference/synchronized signal is specific for specific FTA/MBS service and is propagated by the relevant cell of NG-RAN node (e.g., gNB-DU(s), gNBs) to help the UE obtain the FTA/MBS data within each NR-SFN service area. With respect to inter-cell transmission, the transmitting cells of NG-RAN node(s) must be synchronized by external synchronization and/or internal synchronization. Regarding external synchronization, the NG-RAN node can consider UE assistance information (e.g., UEFTACapability Information, UEFTAReport, UESFNCapability Information, UESFNReport, UEMeasurementReport, etc.) to fine tune the NR-SFN transmission. Regarding internal synchronization, the NG-RAN node can exchange the synchronized associated parameters (e.g., physical clock and/or system frame number) for NR-SFN transmission via Xn interface. In addition to external and/or internal synchronization, a frame handler function within the NG-RAN node (e.g., gNB-CU, gNB) is responsible for setting of the TimeStamp value in order to allow all gNB-DUs/cells to submit the FTA/MBS data in a synchronized manner. The synchronized associated parameters are negotiated by the NG-RAN nodes belonging to the same NR-SFN service area when the service area is setup. When the NG-RAN node is RAN functional split, the TimeStamp value and the synchronized associated parameters are encapsulated in the F1AP message(s) to the involved gNB-DUs as shown in FIG. 10.

A first embodiment of the present disclosure is provided as shown in FIGS. 3 and 7, which depicts implementation scenarios of signal transmission between the UE 10 and the base station 20 according to the present disclosure. The NG-RAN node (e.g., gNB) is configured to enable simultaneous unicast, NR MBS and NR-SFN operations on the common physical channel (e.g., PDCCH and PDSCH) within the cells of intra-DU (i.e., multi-cell transmission within the same MAC scheduler) via various technologies (e.g., time/frequency/spatial domain resolution, etc.). The NG-RAN node can transmit unicast and FTA/MBS via DRB and/or MRB dynamically and simultaneously based on UE assistance information and RAN-based NR-SFN delivery procedure. In this embodiment, the TimeStamp value and the synchronized associated parameters are optional encapsulated in the F1AP message(s) to the involved gNB-DU. The gNB-DU would coordinate the NR-SFN transmission without inter-gNB-CU negotiation. The UE can optionally report the UE assistance information and switch to receive unicast and FTA/MBS data on TDMed/FDMed/SDMed resource within the cells of the activated BWP. In some cases, there are more than one active BWP can be activated from UE perspective. The UE has higher RF capability (e.g., more than two RF chains) so that unicast, NR MBS and NR-SFN reception can be performed on different BWPs if necessary. In further cases, the NG-RAN node would configure SC-PTM and NR-SFN transmission for cell-center UEs and cell-edge UEs respectively depending on UE assistance information/estimated channel quality/QoS requirement, if necessary. Furthermore, the NG-RAN node can decide to transmit FTA/MBS data via SC-PTM and NR-SFN operation based on a configurable SFN-based range threshold within the specific NG-RAN node.

A second embodiment of the present disclosure is provided as shown in FIGS. 3 and 7, which depicts implementation scenarios of signal transmission between the UE 10 and the base station 20 according to the present disclosure. The NG-RAN node (e.g., gNB) is configured to enable simultaneous unicast, NR MBS and NR-SFN operations on the common physical channel (e.g., PDCCH and PDSCH) within the cells of inter-DU of intra-CU (i.e., multi-cell transmission within the same radio resource manager (RRM)) via various technologies (e.g., time/frequency/spatial domain resolution, etc.). The NG-RAN node can transmit unicast and FTA/MBS via DRB and/or MRB dynamically and simultaneously based on UE assistance information and RAN-based NR-SFN delivery procedure. In this embodiment, the TimeStamp value and the synchronized associated parameters are optional encapsulated in the F1AP message(s) to the involved gNB-DUs. The gNB-CU would coordinate the NR-SFN transmission without inter-gNB-CU negotiation. The UE can optionally report the UE assistance information and switch to receive unicast and FTA/MBS data on TDMed/FDMed/SDMed resource within the cells of the activated BWP. In some cases, there are more than one active BWP can be activated from UE perspective. The UE has higher RF capability (e.g., more than two RF chains) so that unicast, NR MBS and NR-SFN reception can be performed on different BWPs if necessary. In further cases, the NG-RAN node would configure SC-PTM and NR-SFN transmission for cell-center UEs and cell-edge UEs respectively depending on UE assistance information/estimated channel quality/QoS requirement, if necessary. Furthermore, the NG-RAN node can decide to transmit FTA/MBS data via SC-PTM and NR-SFN operation based on a configurable SFN-based range threshold within the specific NG-RAN node.

A third embodiment of the present disclosure is as shown in FIGS. 3 and 7, which depicts implementation scenarios of signal transmission between the UE 10 and the base station 20 according to the present disclosure. The NG-RAN nodes (e.g., gNBs) are configured to enable simultaneous unicast, NR MBS and NR-SFN operations on the common physical channel (e.g., PDCCH and PDSCH) within the cells of inter-CU (i.e., multi-cell transmission within the same NR-SFN service area) via various technologies (e.g., time/frequency/spatial domain resolution, etc.). The NG-RAN node can transmit unicast and FTA/MBS via DRB and/or MRB dynamically and simultaneously based on UE assistance information and RAN-based NR-SFN delivery procedure. In this embodiment, the TimeStamp value and the synchronized associated parameters are encapsulated in the F1AP message(s) to the involved gNB-DUs and gNB-CUs. Each gNB-CU would coordinate the NR-SFN transmission via inter-gNB-CU negotiation. The UE can optionally report the UE assistance information and switch to receive unicast and FTA/MBS data on TDMed/FDMed/SDMed resource within the cells of the activated BWP. In some cases, there are more than one active BWP can be activated from UE perspective. The UE has higher RF capability (e.g., more than two RF chains) so that unicast, NR MBS and NR-SFN reception can be performed on different BWPs if necessary. In further cases, the NG-RAN node would configure SC-PTM and NR-SFN transmission for cell-center UEs and cell-edge UEs respectively depending on UE assistance information/estimated channel quality/QoS requirement, if necessary. Furthermore, the NG-RAN node can decide to transmit FTA/MBS data via SC-PTM and NR-SFN operation based on a configurable SFN-based range threshold within the specific NG-RAN node.

A fourth embodiment of the present disclosure is provided as shown in FIG. 7, which depicts implementation scenarios of signal transmission between the UE 10 and the base station 20 according to the present disclosure. The NG-RAN nodes (e.g., gNBs) are configured to enable simultaneous unicast, NR MBS and NR-SFN operations on the common physical channel (e.g., PDCCH and PDSCH) within the cells of primary/secondary carrier component(s) (i.e., carrier aggregation within the same NR-SFN service area) via various technologies (e.g., time/frequency/spatial domain resolution, etc.). The NG-RAN node can transmit unicast and FTA/MBS via DRB and/or MRB dynamically and simultaneously based on UE assistance information and RAN-based NR-SFN delivery procedure. In this embodiment, the TimeStamp value and the synchronized associated parameters are encapsulated in the cross-carrier scheduling and inter-node messages to the involved carrier components. Each primary carrier component would coordinate the NR-SFN transmission via inter-node negotiation. The UE can optionally report the UE assistance information and switch to receive unicast and FTA/MBS data on TDMed/FDMed/SDMed resource within the cells of the activated BWP. In some cases, there are more than one active BWP can be activated from UE perspective. The UE has higher RF capability (e.g., more than two RF chains) so that unicast, NR MBS and NR-SFN reception can be performed on different BWPs if necessary. In further cases, the NG-RAN node would configure SC-PTM and NR-SFN transmission for cell-center UEs and cell-edge UEs respectively depending on UE assistance information/estimated channel quality/QoS requirement, if necessary. Furthermore, the NG-RAN node can decide to transmit FTA/MBS data via SC-PTM and NR-SFN operation based on a configurable SFN-based range threshold within the specific carrier component.

A fifth embodiment of the present disclosure is provided as shown in FIG. 7, which depicts implementation scenarios of signal transmission between the UE 10 and the base station 20 according to the present disclosure. The NG-RAN nodes (e.g., gNBs) are configured to enable simultaneous unicast, NR MBS and NR-SFN operations on the common physical channel (e.g., PDCCH and PDSCH) within the cells of master/secondary cell group(s) (i.e., inter-site carrier aggregation within the same NR-SFN service area) via various technologies (e.g., time/frequency/spatial domain resolution, etc.). The NG-RAN node can transmit unicast and FTA/MBS via DRB and/or MRB dynamically and simultaneously based on UE assistance information and RAN-based NR-SFN delivery procedure. In this embodiment, the TimeStamp value and the synchronized associated parameters are encapsulated in the inter-node messages to the involved gNBs. The master cell group (MCG) would coordinate the NR-SFN transmission via inter-node negotiation. The UE can optionally report the UE assistance information and switch to duplicative receive unicast and FTA/MBS data on TDMed/FDMed/SDMed resource within the cells of the activated BWP. In some cases, there are more than one active BWP can be activated from UE perspective. The UE has higher RF capability (e.g., more than two RF chains) so that unicast, NR MBS and NR-SFN reception can be performed on different BWPs if necessary. In further cases, the NG-RAN node would configure SC-PTM and NR-SFN transmission for cell-center UEs and cell-edge UEs respectively depending on UE assistance information/estimated channel quality/QoS requirement, if necessary. Furthermore, the NG-RAN node can decide to transmit FTA/MBS data via SC-PTM and NR-SFN operation based on a configurable SFN-based range threshold within the specific NR-SFN service area.

A sixth embodiment of the present disclosure is provided as shown in FIGS. 3 and 7, which depicts implementation scenarios of signal transmission between the UE 10 and the base station 20 according to the present disclosure. The NG-RAN nodes (e.g., gNBs) are configured to enable simultaneous unicast, NR MBS and NR-SFN operations on the common physical channel (e.g., PDCCH and PDSCH) within the cells of sharing PLMNs (i.e., RAN sharing within the same NR-SFN service area) via various technologies (e.g., time/frequency/spatial domain resolution, etc.). A RAN sharing architecture allows multiple PLMNs to share radio resources of a shared radio access network according to the pre-planned and system level agreements. In some cases, different PLMN identifiers can also point to the same 5GC. The NG-RAN node can transmit unicast and FTA/MBS via DRB and/or MRB dynamically and simultaneously based on UE assistance information and RAN-based NR-SFN delivery procedure. In this embodiment, the TimeStamp value and the synchronized associated parameters are encapsulated in the FLAP message(s) to the involved cells of sharing PLMNs. The sharing PLMNs would coordinate the NR-SFN transmission via inter-PLMN negotiation. The UE can optionally report the UE assistance information and switch to receive unicast and FTA/MBS data on TDMed/FDMed/SDMed resource within the cells of the activated BWP. In some cases, there are more than one active BWP can be activated from UE perspective. The UE has higher RF capability (e.g., more than two RF chains) so that unicast, NR MBS and NR-SFN reception can be performed on different BWPs if necessary. In further cases, the NG-RAN node would configure SC-PTM and NR-SFN transmission for cell-center UEs and cell-edge UEs respectively depending on UE assistance information/estimated channel quality/QoS requirement, if necessary. Furthermore, the NG-RAN node can decide to transmit FTA/MBS data via SC-PTM and NR-SFN operation based on a configurable SFN-based range threshold within the specific sharing RAN.

Commercial interests for some embodiments are as follows. 1. solving issues in the prior art. 2. improving an issue of increasing in service requirement and inter-site interference. 3. providing a good communication performance. 4. providing high resource efficiency. Some embodiments of the present disclosure are used by 5G-NR chipset vendors, V2X communication system development vendors, automakers including cars, trains, trucks, buses, bicycles, moto-bikes, helmets, and etc., drones (unmanned aerial vehicles), smartphone makers, communication devices for public safety use, AR/VR device maker for example gaming, conference/seminar, education purposes. Some embodiments of the present disclosure are a combination of “techniques/processes” that can be adopted in 3GPP specification to create an end product. Some embodiments of the present disclosure could be adopted in the 5G NR unlicensed band communications. Some embodiments of the present disclosure propose technical mechanisms.

The embodiment of the present application further provides a computer readable storage medium for storing a computer program. The computer readable storage medium enables a computer to execute corresponding processes implemented by the UE/BS in each of the methods of the embodiment of the present disclosure. For brevity, details will not be described herein again.

The embodiment of the present application further provides a computer program product including computer program instructions. The computer program product enables a computer to execute corresponding processes implemented by the UE/BS in each of the methods of the embodiment of the present disclosure. For brevity, details will not be described herein again.

The embodiment of the present application further provides a computer program. The computer program enables a computer to execute corresponding processes implemented by the UE/BS in each of the methods of the embodiment of the present disclosure. For brevity, details will not be described herein again.

Although not shown in detail any of the devices or apparatus that form part of the network may include at least a processor, a storage unit and a communications interface, wherein the processor unit, storage unit, and communications interface are configured to perform the method of any aspect of the present invention. Further options and choices are described below.

The signal processing functionality of the embodiments of the invention especially the gNB and the UE may be achieved using computing systems or architectures known to those who are skilled in the relevant art. Computing systems such as, a desktop, laptop or notebook computer, hand-held computing device (PDA, cell phone, palmtop, etc.), mainframe, server, client, or any other type of special or general purpose computing device as may be desirable or appropriate for a given application or environment can be used. The computing system can include one or more processors which can be implemented using a general or special-purpose processing engine such as, for example, a microprocessor, microcontroller or other control module.

The computing system can also include a main memory, such as random access memory (RAM) or other dynamic memory, for storing information and instructions to be executed by a processor. Such a main memory also may be used for storing temporary variables or other intermediate information during execution of instructions to be executed by the processor. The computing system may likewise include a read only memory (ROM) or other static storage device for storing static information and instructions for a processor.

The computing system may also include an information storage system which may include, for example, a media drive and a removable storage interface. The media drive may include a drive or other mechanism to support fixed or removable storage media, such as a hard disk drive, a floppy disk drive, a magnetic tape drive, an optical disk drive, a compact disc (CD) or digital video drive (DVD) read or write drive (R or RW), or other removable or fixed media drive. Storage media may include, for example, a hard disk, floppy disk, magnetic tape, optical disk, CD or DVD, or other fixed or removable medium that is read by and written to by media drive. The storage media may include a computer-readable storage medium having particular computer software or data stored therein.

In alternative embodiments, an information storage system may include other similar components for allowing computer programs or other instructions or data to be loaded into the computing system. Such components may include, for example, a removable storage unit and an interface, such as a program cartridge and cartridge interface, a removable memory (for example, a flash memory or other removable memory module) and memory slot, and other removable storage units and interfaces that allow software and data to be transferred from the removable storage unit to computing system.

The computing system can also include a communications interface. Such a communications interface can be used to allow software and data to be transferred between a computing system and external devices. Examples of communications interfaces can include a modem, a network interface (such as an Ethernet or other NIC card), a communications port (such as for example, a universal serial bus (USB) port), a PCMCIA slot and card, etc. Software and data transferred via a communications interface are in the form of signals which can be electronic, electromagnetic, and optical or other signals capable of being received by a communications interface medium.

In this document, the terms ‘computer program product’, ‘computer-readable medium’ and the like may be used generally to refer to tangible media such as, for example, a memory, storage device, or storage unit. These and other forms of computer-readable media may store one or more instructions for use by the processor including the computer system to cause the processor to perform specified operations. Such instructions, generally referred to as ‘computer program code’ (which may be grouped in the form of computer programs or other groupings), when executed, enable the computing system to perform functions of embodiments of the present invention. Note that the code may directly cause a processor to perform specified operations, be compiled to do so, and/or be combined with other software, hardware, and/or firmware elements (e.g., libraries for performing standard functions) to do so.

The non-transitory computer readable medium may include at least one from a group consisting of: a hard disk, a CD-ROM, an optical storage device, a magnetic storage device, a Read Only Memory, a Programmable Read Only Memory, an Erasable Programmable Read Only Memory, EPROM, an Electrically Erasable Programmable Read Only Memory and a Flash memory. In an embodiment where the elements are implemented using software, the software may be stored in a computer-readable medium and loaded into computing system using, for example, removable storage drive. A control module (in this example, software instructions or executable computer program code), when executed by the processor in the computer system, causes a processor to perform the functions of the invention as described herein.

Furthermore, the inventive concept can be applied to any circuit for performing signal processing functionality within a network element. It is further envisaged that, for example, a semiconductor manufacturer may employ the inventive concept in a design of a stand-alone device, such as a microcontroller of a digital signal processor (DSP), or application-specific integrated circuit (ASIC) and/or any other sub-system element.

It will be appreciated that, for clarity purposes, the above description has described embodiments of the invention with reference to a single processing logic. However, the inventive concept may equally be implemented by way of a plurality of different functional units and processors to provide the signal processing functionality. Thus, references to specific functional units are only to be seen as references to suitable means for providing the described functionality, rather than indicative of a strict logical or physical structure or organization.

Aspects of the invention may be implemented in any suitable form including hardware, software, firmware or any combination of these. The invention may optionally be implemented, at least partly, as computer software running on one or more data processors and/or digital signal processors or configurable module components such as FPGA devices.

Thus, the elements and components of an embodiment of the invention may be physically, functionally and logically implemented in any suitable way. Indeed, the functionality may be implemented in a single unit, in a plurality of units or as part of other functional units. Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term ‘comprising’ does not exclude the presence of other elements or steps.

Furthermore, although individually listed, a plurality of means, elements or method steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather indicates that the feature is equally applicable to other claim categories, as appropriate.

Furthermore, the order of features in the claims does not imply any specific order in which the features must be performed and in particular the order of individual steps in a method claim does not imply that the steps must be performed in this order. Rather, the steps may be performed in any suitable order. In addition, singular references do not exclude a plurality. Thus, references to ‘a’, ‘an’, ‘first’, ‘second’, etc. do not preclude a plurality.

While the present application has been described in connection with what is considered the most practical and preferred embodiments, it is understood that the present application is not limited to the disclosed embodiments but is intended to cover various arrangements made without departing from the scope of the broadest interpretation of the appended claims.

1-50. (canceled)

51. A method of wireless communication, comprising:
transmitting UE assistance information to a network node; and
receiving, by a user equipment (UE), unicast and a broadcast service simultaneously transmitted on a common physical channel based on the UE assistance information from the network node.

52. The method of claim 51, wherein the UE assistance information comprises at least one of UE capability, measurement report, or Free-to-Air (FTA) reception/Radio Access Network (RAN) sharing status report.

53. The method of claim 51, wherein multiple Subscriber Identity Module (SIM) cards are supported for the UE to receive data including the unicast and the broadcast service, and the data including the unicast and the broadcast service are from the same or different operators.

54. The method of claim 51, wherein the broadcast service comprises at least one of FTA or multicast and broadcast service (MBS).

55. The method of claim 54, wherein in the receiving step, at least one of the unicast or the MBS are received by the UE on resources configured according to the FTA after the FTA is determined to be transmitted.

56. The method of claim 54, wherein in the receiving step, the broadcast service is received under a RAN-based single frequency network (SFN).

57. The method of claim 56, wherein an enhanced frame structure comprising at least one of SFN-based subframe, self-contained subframe for reliable ACK/NACK, or common frequency resource (CFR) is used to enlarge a service area of the RAN-based SFN.

58. The method of claim 56, wherein a flexible numerology is used in the RAN-based SFN to allow a range of at least one of cyclic prefix or subcarrier spacing with different slot lengths.

59. The method of claim 51, wherein the broadcast service comprises MBS, and in the receiving step the MBS is received by Single-Cell Point-to-Multipoint (SC-PTM).

60. The method of claim 59, wherein which one of multicast radio bearer (MRB) and unicast data radio bearer (DRB) is adopted to receive the MBS is decided by the network node based on MBS session QoS requirement.

61. The method of claim 59, wherein which one of point-to-point (PTP) and point-to-multipoint (PTM) is used for an MBS session reception is decided by the network node based on the channel quality.

62. The method of claim 59, wherein the SC-PTM using PTM transmission is received by MRB as well as PDCCH-scheduled PTM PDSCH data is scrambled by a Group-RNTI (G-RNTI).

63. The method of claim 59, wherein the SC-PTM using PTP transmission is received by DRB as well as PDCCH-scheduled PTP PDSCH data is scrambled by a Cell-RNTI (C-RNTI).

64. The method of claim 51, wherein the broadcast service comprises MBS, and which one of RAN-based SFN and SC-PTM is adopted to receive MBS is decided by the network node.

65. The method of claim 64, further comprising:
if the UE is a cell-center UE, being configured by the network node SC-PTM reception; and
if the UE is a cell-edge UE, being configured by the network node RAN-based SFN reception.

66. The method of claim 51, wherein adaptive modulation and coding scheme (MCS) is configured to SC-PTM and RAN-based SFN transmission for cell-center UEs and cell-edge UEs respectively depending on the UE assistance information.

67. The method of claim 51, further comprising:
receiving a RAN-based SFN-specific reference or synchronized signal pattern for UE synchronization, wherein the RAN-based SFN-specific reference or synchronized signal pattern is same for all the cells belonging to a RAN-based SFN service area.

68. The method of claim 51, wherein the network node is one of the followings: one of cells of intra-distributed unit (DU), one of cells of inter-DU of intra-centralized unit (CU), one of cells of inter-CU, one of cells of primary/secondary carrier component, one of cells of master/secondary cell group, or one of cells of sharing public land mobile networks (PLMNs).

69. A user equipment (UE), comprising a memory, at least one transceiver and a processor coupled to the memory and the at least one transceiver, the processor configured to call and run program instructions stored in a memory, to execute the following operations:
transmitting UE assistance information to a network node; and
receiving, by a user equipment (UE), unicast and a broadcast service simultaneously transmitted on a common physical channel based on the UE assistance information from the network node.

70. A network node, comprising a memory, at least one transceiver and a processor coupled to the memory and the at least one transceiver, the processor configured to call and run program instructions stored in a memory, to execute the following operations:
receiving UE assistance information from user equipment (UEs); and
transmitting, by the network node, unicast and a broadcast service simultaneously on a common physical channel based on the UE assistance information.
